(19) United States
(12) Patent Application Publication
(10) Pub. No.: US 2014/0265365 A1
(43) Pub. Date: Sep. 18, 2014

(54) PUSH-PUSH LATCH ARRANGEMENT

(71) Applicant: FAURECIA INTERIOR SYSTEMS, INC., Aubum Hills, MI (US)

(72) Inventor: Larry Vigneau, Auburn Hills, MI (US)

(73) Assignee: FAURECIA INTERIOR SYSTEMS, INC., Auburn Hills, MI (US)

(21) Appl. No.: 13/837,275

(22) Filed: Mar. 15, 2013

(51) Int. Cl. E05B 65/12

(52) U.S. Cl. CPC E05B 83/30; E05B 83/28
USPC 292/198

(57) ABSTRACT

A push-push latch arrangement includes, but is not limited to, a trim component that is configured to move between a first position and a second position. The trim component has a push-push pathway. The push-push latch arrangement further includes, but is not limited to, a latch component having a pathway follower. The pathway follower is engaged with the push-push pathway. The latch component is configured for movement with respect to the push-push pathway to enable the pathway follower to follow the push-push pathway as the trim component moves between the first position and the second position. The push-push latch arrangement further includes, but is not limited to, a first biasing component urging the pathway follower towards an egress segment of the push-push pathway. The push-push latch arrangement still further includes, but is not limited to, a damper engaged with the latch component and dampening movement of the latch component.

### TECHNICAL FIELD

The technical field generally relates to vehicles, and more particularly relates to push-push latch arrangements for use in vehicles.

### BACKGROUND

When designing movable trim components such as bin covers, glove box closures, and the like, for vehicle interiors, it is desirable to present a vehicle occupant with an uninterrupted surface. Uninterrupted surfaces are generally perceived as being more aesthetically pleasing than a surface having knobs, buttons, or other interruptions. The movement of such movable trim components from a closed position to an open position is commonly controlled by a latch arrangement. A conventional latch arrangement may use a button, a switch, a lever, a clasp or other release mechanism to lock and unlock movement of the movable trim component. Such release mechanisms visually disrupt an otherwise uninterrupted surface of the movable trim component.

One latch arrangement that avoids the use of a visible release mechanism is a conventional push-push latch arrangement. A conventional push-push latch arrangement enables a user to push on the movable trim component itself rather than actuating a button, a switch, a lever, a clasp, or any other visible actuator. In response to the push, hidden components of the conventional push-push latch arrangement will move with respect to one another and will cause the movable trim component to become locked in a closed position. A second push on the movable trim component will release the movable trim component and permit it to move to an open position. A further push will start the lock-unlock cycle over again.

While conventional push-push latch arrangements are aesthetically pleasing, under certain circumstances, they can be disadvantageous. For example, if the movable trim component is oriented such that the actuating push is aligned with the direction of vehicle travel, then in a head-on or a rear-end collision, the push-push latch arrangement may react to the collision force as though a push had been initiated. This, in turn, may allow the movable trim component to become unlatched and it may move to the open position. This is undesirable.

One known solution is described in U.S. Pat. No. 5,647,578, issued to Bivens and entitled “Latch Mechanism” (hereinafter, “Bivens”). Bivens discloses the use of a damper in conjunction with a push-push latch mechanism to dampen the rate at which a movable trim component can be opened. This solution may be fine for preventing damage to the movable trim component as it opens unexpectedly, but it does not sufficiently address the problem described above. Depending upon the severity of a collision, the forces exerted on a movable trim component during the collision may exceed the dampening force of the damper and the movable trim component may open during the collision despite the presence of the damper.

Accordingly, it would be desirable to introduce a push-push latch arrangement that does not open during a vehicle collision. Furthermore, other desirable features and characteristics will become apparent from the subsequent detailed description and the appended claims, taken in conjunction with the accompanying drawings and the foregoing technical field and background.

### SUMMARY

Various embodiments of a push-push latch arrangement are disclosed herein. In a non-limiting embodiment, the push-push latch arrangement includes, but is not limited to, a trim component that is configured to move between a first position and a second position. The push-push latch arrangement further includes, but is not limited to, a latch component that is configured to engage the trim component. The latch component is configured to move with respect to the trim component as the trim component moves between the first position and the second position. The push-push latch arrangement further includes, but is not limited to, a push-push pathway that is associated with one of the trim component and the latch component. The push-push latch arrangement further includes, but is not limited to, a pathway follower that is associated with another of the trim component and the latch component. The pathway follower is engaged with the push-push pathway. The push-push latch arrangement further includes, but is not limited to, a first biasing component urging the pathway follower towards an egress segment of the push-push pathway. The push-push latch arrangement still further includes, but is not limited to, a damper that is engaged with the latch component and dampening movement of the latch component.

### DESCRIPTION OF THE DRAWINGS

One or more embodiments will hereinafter be described in conjunction with the following drawing figures, wherein like numerals denote like elements, and

FIG. 1 is a perspective view illustrating an interior of a vehicle;

FIG. 2 is a perspective view illustrating a dashboard bin cover in an open position, the bin cover utilizing an embodiment of a push-push latch arrangement made in accordance with the teachings of the present disclosure;

FIG. 3 is a perspective view illustrating an embodiment of push-push latch arrangement made in accordance with the teachings of the present disclosure;

FIG. 4 is a fragmented perspective view illustrating a portion of the bin cover of FIG. 2 including a push-push pathway;

FIG. 5 is a perspective view illustrating a latch component configured to engage the push-push pathway illustrated in FIG. 4; and

FIG. 6 is a schematic view illustrating engagement between a portion of the trim component of FIG. 5 and the push-push pathway during a typical close/open cycle.

### DETAILED DESCRIPTION

The following detailed description is merely exemplary in nature and is not intended to limit application and uses. Furthermore, there is no intention to be bound by any expressed or implied theory presented in the preceding technical field, background, brief summary or the following detailed description.

An improved push-push latch arrangement is disclosed herein. In a non-limiting embodiment, the push-push latch arrangement includes a push-push pathway. As used herein, the term “push-push pathway” refers to a pathway that may be disposed on, or defined in, the surface of a trim component or on/in a latch that cooperates with the trim component, or in/on another component of the latch arrangement. The pathway is configured to guide a pathway follower. The pathway includes an ingress segment, a clearance segment, and an egress segment. Initially, the pathway will guide the pathway follower along the ingress segment to the clearance segment. Movement of the pathway follower along the ingress segment corresponds with a user's initial push on, but not limited to, an open movable trim component to cause the movable trim component to move to a closed position and to lock in the closed position. When the pathway follower enters and engages the clearance segment, the movable trim component is inhibited from opening by the clearance segment and is “locked”. A subsequent push by the user will cause the pathway follower to exit the clearance segment and to enter the egress segment, thus unlocking the movable component. Movement of the pathway follower along the egress segment corresponds with movement of the movable trim component to the open position. At the end of the egress segment, the pathway follower is positioned to re-enter ingress segment for the next lock/unlock cycle.

While a conventional push-push pathway utilizes the contours of an upper wall of the clearance segment to move the pathway follower towards the egress segment, the push-push latch arrangement disclosed herein omits such contours from the clearance segment and instead utilizes a biasing component that biases the latch component in a direction that urges the pathway follower towards the egress segment. Thus, in an embodiment, once the pathway follower moves past an end of the ingress segment, it is the urging of the biasing component, and not the contours of the clearance segment that will move the pathway follower to the egress segment.

To control the speed at which the pathway follower moves towards the egress segment, the push-push latch arrangement disclosed herein includes a damper that is engaged with the latch component and that dampens or retards the speed of its movement in response to the urging of the biasing component. Thus, instead of simply snapping immediately to the egress segment, the damper will cause the pathway follower to move slowly towards the egress segment despite the urging of the biasing component.

In some embodiments, the movable trim component will include a biasing component that urges the movable trim component towards an open position. In other embodiments, the movable trim component may be mounted at an angle that utilizes gravity to bias it towards an open position. In either configuration, the movable trim component will be urged towards its open position. Thus, after the user's initial push towards the closed position, the movable trim component will start to move towards its open position. At the same time, the latch component will start moving towards the egress segment, but its motion will be slowed by the damper. The clearance segment is configured to “catch” the pathway follower during the simultaneous motion of these two components and to obstruct further movement of the pathway follower towards the egress segment. At the same time, the pathway follower's engagement with the clearance segment will obstruct further movement of the movable trim component towards its open position.

When the user pushes the movable trim component a second time, the pathway follower is moved past an end of the clearance segment and the biasing component will then move the pathway follower to the entrance of the egress segment. Movement of the pathway follower to the entrance of the egress segment, however, will be slowed by the damper.

By selecting a damper that provides a desired amount of resistance, the amount of time taken by the pathway follower to move to the entrance of the egress segment can be tailored to meet most desired time requirements. This feature permits designers to prevent movable trim components from unintentionally opening during head on or rear end collisions. The forces exerted during such collisions are typically applied over about a five millisecond period of time. If a damper is selected that causes the pathway follower to take longer than about five milliseconds (or any other specified time period) before entering the egress segment, then the force exerted on the movable trim component during the collision will dissipate before the pathway follower becomes disengaged from the clearance segment and the movable trim component will therefore remain locked.

An additional advantage of the push-push latch arrangement disclosed herein is that the biasing component that urges the latch component towards the egress segment and the biasing component that urges the movable trim component towards the open position may comprise springs. Springs are readily available in the market place and are relatively inexpensive.

An additional advantage of the push-push latch arrangement disclosed herein is that an outer wall of the clearance segment may have a concave arc along substantially its entire length (e.g., the arc illustrated at the top of the run in FIGS. 4 and 6). This contour ensures the absence of any topographical features that might otherwise urge the pathway follower towards the egress pathway more quickly than desired.

An additional advantage of the push-push latch arrangement disclosed herein is that both the movable trim component and the latch component may pivot as they move. This permits a simple construction that utilizes well known components that are readily available in the market.

An additional advantage of the push-push latch arrangement disclosed herein is that, the pathway follower may have a contour that is configured to conform to a contour of the clearance segment. This can help to ensure a robust and substantially rattle-free engagement between the latch component and the movable trim component.

An additional advantage of the push-push latch arrangement disclosed herein is that the damper may comprise a viscous rotary damper. Such dampers are well known, readily available, relatively inexpensive and are dimensioned to easily fit within a limited package space and have various viscosities.

A greater understanding of the push-push latch arrangement described above may be obtained through a review of the illustrations accompanying this application together with a review of the detailed description that follows.

FIG. 1 is a perspective view illustrating an interior portion 10 of a vehicle. Interior 10 includes a dashboard 12 having two movable trim components, a glove box door 14 and a bin cover 16. Bin cover 16 is configured to move between a closed position (as illustrated in FIG. 1) and an open position (see FIG. 2). When moving to its open position, bin cover 16 pivots in an upward direction. It therefore requires the assistance of a biasing component, such as a spring, to open when unlatched. Glove box door 14 is similarly configured to move between a closed position (as illustrated in FIG. 1) and an open position (not shown). However, glove box door 14 pivots in a downward direction when opening and therefore may rely on the force of gravity to open when unlatched. Movement of both glove box door 14 and bin cover 16 is controlled by an embodiment of the push-push latch arrangement disclosed herein. For this reason, neither glove box door 14 nor bin cover 16 have any visible release mechanisms interrupting their surfaces and accordingly have a visual appearance that is more aesthetically pleasing than conventional glove box doors and bin covers.

FIG. 2 is a perspective view illustrating an expanded view of bin cover 16. In this view, bin cover 16 is illustrated in an open position, revealing bin 18 below. Also partially visible in this view is hinge 20 which is attached to bin cover 16. Hinge 20 pivotally mounts bin cover 16 to dash board 12 or storage housing and guides bin cover 16 as it moves between the open and closed positions. An additional hinge (not shown) is disposed on the opposite side of bin cover 16 and cooperates with bin cover 16 to guide bin cover 16 between the open and closed positions. A portion of hinge 20 extends below the surface of dashboard 12. In the illustrated embodiment, the portion of hinge 20 that extends below the surface of dashboard 12 comprises part of the push-push latch arrangement of the present disclosure. In other embodiments, hinge 20 may be attached to a component that comprises part of the push-push latch arrangement.

FIG. 3 is a perspective view illustrating a non-limiting embodiment of a push-push latch arrangement 22 made in accordance with the teachings of the present disclosure. Push-push latch arrangement 22 includes hinge 20, a latch 24, a damper 26, a latch-engaging spring 28, and a pair of hinge-engaging springs 30.

As will be discussed in greater detail below, in the illustrated embodiment, hinge 20 includes a push-push pathway and latch 24 is includes a pathway follower that is configured to engage the push-push pathway. To facilitate such engagement, latch 24 is pivotally mounted to a housing or to some other suitable surface within dashboard 12 (see FIG. 1) that disposes latch 24 in a position where it is enabled to engage the push-push pathway. Latch 24 is configured to pivot laterally as illustrated by phantom lines 66 to permit a pathway follower (see FIG. 5) to follow the push-push pathway. It should be understood that the illustrated embodiment is only exemplary. In other embodiments, the push-push pathway may be disposed on the latch and the pathway follower may be disposed on the trim component without departing from the teachings of the present disclosure.

In the illustrated embodiment, damper 26 is viscous rotary damper. In the illustrated embodiment, damper 26 includes gear teeth 32. A lower portion of latch 24 includes gear teeth 34 in meshed engagement with gear teeth 32. Engaged in this manner, the pivotal motion of latch 24 is retarded by damper 26. In other embodiment, rather than being in meshed engagement, damper 26 and latch 24 may be engaged in any other manner that is effective to dampen the pivoting motion of latch 24.

Latch-engaging spring 28 is connected at end 36 to latch 24 and is connected at an opposite end 38 to a housing or to any other suitable surface within dashboard 12 (see FIG. 1). Latch-engaging spring 28 is in tension and is configured to urge latch 24 to pivot towards end 38. As will be discussed later, this tension urges the pathway follower on latch 24 towards an egress segment of the push-push pathway. As discussed above, this pivotal motion of latch 24 is dampened by damper 26. In other embodiments, different configurations are possible without departing from the teachings of the present disclosure. For example, while the illustrated embodiment depicts latch-engaging spring 28 as being in tension and urging latch 24 towards end 38, in other examples, latch-engaging spring 28 may be attached to an opposite side of latch 24 and may be in compression such that latch 24 would be pushed rather than pulled in a desired direction. In still other embodiments, a torsional spring may coupled with a center of latch 24 and with a feature of a surface that latch 24 is mounted to.

Hinge-engaging springs 30 are mounted at respective ends 40 to a lower portion of hinge 20 and are mounted at respective opposite ends 42 to a housing or other suitable surface within dashboard 12 (see FIG. 1). In the illustrated embodiment, hinge-engaging springs 30 are in compression and pushes hinge 20 in an upward direction (from the perspective of FIG. 3). This force pushes bin cover 16 (see FIG. 2) towards the open position. In other embodiments, different configurations are possible such that hinge-engaging springs 30 may be in tension and may pull hinge 20 in an upward direction.

FIG. 4 is a perspective view illustrating a lower portion of hinge 20 of push-push latch arrangement 22. With continuing reference to FIG. 3, in FIG. 4, latch 24, latch-engaging spring 28, and damper 26 are not shown, revealing a push-push pathway 44 defined in hinge 20. While the illustrated embodiment depicts push-push pathway 44 as being integrated into hinge 20, with walls and a channel floor that are defined below a surface of hinge 20, in other embodiments, the walls of push-push pathway 44 may protruded outwardly from a surface of hinge 20 without departing from the teachings of the present disclosure.

Push-push pathway 44 includes an ingress segment 46, a clearance segment 48, and an egress segment 50. Push-push pathway 44 further includes a gate 51 that is configured to swing in the direction indicated by arrow 53, but which is biased in the opposite direction by a spring (not shown). Gate 51 is configured to permit a pathway follower to exit a lower portion of egress segment 50 and to inhibit a pathway follower from entering the lower portion of egress segment 50. In other embodiments, gate 51 may be omitted and other mechanisms or configurations may be utilized to inhibit the pathway follower from entering the lower portion of egress segment 50. In other embodiments, push-push pathway 44 may be configured to avoid the need for gate 51. This is illustrated with phantom lines 66 in FIG. 6.

FIG. 5 is a perspective view illustrating latch 24 of push-push latch arrangement 22. With continuing reference to FIGS. 3-4, in FIG. 5, a side of latch 24 that was hidden from view in FIG. 3 is now visible. Protruding from latch 24 is pathway follower 52. Pathway follower 52 is configured to fit between the walls of push-push pathway 44 and to be guided by those walls along ingress segment 46 and egress segment 50 and is further configured to engage clearance segment 48.

With continuing reference to FIGS. 1-5, FIG. 6 is a schematic view illustrating the engagement between pathway follower 52 and push-push pathway 44 during an exemplary cycle wherein bin cover 16 is first closed and then opened.

With bin cover 16 starting in an open position, pathway follower 52 is disposed at location A. When a user pushes down on bin cover 16, the urging force of hinge-engaging springs 30 is overcome and hinge 20 will begin to move in a downward direction into dashboard 12. This will cause push-push pathway 44 to move in a downward direction past pathway follower 52. This is illustrated by pathway follower 52 moving from position A to position B. Because of the urging of latch-engaging spring 28, pathway follower 52 will be urged against a left side wall 54 of push-push pathway 44.

As push-push pathway 44 continues to move downwardly past pathway follower 52, pathway follower will 52 encounter gate 51. This occurs when pathway follower 52 reaches position C. At position C, gate 51 obstructs pathway follower 52 from entering egress segment 50 and consequently, pathway follower 52 enters ingress segment 46 and slides along left side wall 56. In embodiments of push-push pathway 44 that lack gate 51 (such as the embodiment shown in phantom lines 66 in FIG. 6), the combination of a lateral offset built into pathway 44 and damper 26 will inhibit pathway follower 52 from entering egress pathway 50 as pathway follower 52 is pushed upward toward ingress pathway 56.

As bin cover 16 is further pushed by a user towards its closed position, pathway follower 52 continues to move along ingress segment 46, as illustrated by pathway follower's 52 presence at position D. At position E, pathway follower 52 has reached the end of left side wall 56. As pathway follower 52 moves past the end of left side wall 56, because there is no longer any structure inhibiting pathway follower 52 from movement towards egress segment 50, latch-engaging spring 28 will begin to move pathway follower 52 towards egress segment 50. However, because damper 26 retards the pivoting motion of latch 24, pathway follower 52 does not immediately snap to left side wall 58. Rather, it begins to gradually move towards left side wall 58. At the same time, the user is continuing to push on bin cover 16, so pathway follower 52 continues until its movement is stopped elsewhere in the bin housing.

Ultimately, pathway follower 52 arrives at point F, where it is obstructed from further relative upward movement by a stop elsewhere in bin housing and where push-push pathway 44 is obstructed from further relative downward movement by pathway follower 52. This obstruction is transmitted to the user in the form of haptic feedback—the user can feel the obstruction, will stop pushing on bin cover 16, and will release it.

Once the user releases bin cover 16, hinge-engaging springs 30 will once again urge bin cover 16 towards the open position. This will cause hinge 20 and push-push pathway 44 to begin moving in the opposite direction. As a result, pathway follower 52 will begin to move downwardly away from upper wall 60. At the same time, latch-engaging spring will continue to pull latch 24 and pathway follower 52 towards egress segment 50. The concerted forces exerted by latch-engaging spring 28 and hinge-engaging springs 30 will cause pathway follower 52 to move along a diagonal line (from the perspective of push-push pathway 44). This is illustrated by the presence of pathway follower 52 at position G.

As pathway follower 52 continues along this diagonal pathway, it will encounter a lower wall 62 of clearance segment 48 at position H. In the illustrated example, lower wall 62 has a “V” shaped configuration. This configuration will cause pathway follower 52 and push-push pathway 44 to interfere with one another. Pathway follower 52 will engage lower wall 62 and will obstruct further upward movement of bin cover 16. Similarly, lower wall 62 will engage pathway follower 52 and will obstruct further movement of pathway follower 52 towards egress segment 50. With pathway follower 52 situated at position H, bin cover 16 is locked in the closed position and pathway follower 52 will remain in this position until another push is applied to bin cover 16.

When the user wishes to access bin 18, the user will apply a second push to bin cover 16. This push will overcome the urging of hinge-engaging springs 30 and will cause push-push pathway to once again move in a downward direction with respect to pathway follower 52. This will cause pathway follower 52 to move upward with respect to lower wall 62. With pathway follower 52 now free of the obstruction caused by lower wall 62, pathway follower 52 will begin to move towards egress segment 50 under the urging of latch-engaging spring 28. However, because of the retarding effect of damper 26, such movement is slowed and pathway follower 52 will again move in a diagonally upward direction (see pathway follower 52 at position I) instead of sliding along a left side of lower wall 62.

It is this retarded motion that enables bin cover 16 to remain closed in the event of a collision. While the force of a collision may be sufficient to cause bin cover 16 to be pushed inward and to consequently move pathway follower 52 up and out of engagement with lower wall 62, the collision force will not be sustained for a long enough period of time to allow pathway follower 52 to move beyond an end 64 of lower path 62 because the pivotal motion of latch 24 is slowed by damper 26. If pathway follower 52 cannot get clear of end 64 before the force of the collision dissipates, then the urging of hinge-engaging springs 30 in combination with the camming surface of lower wall 62 will cause pathway follower 52 to return to position H. Further contributing to pathway follower 52 not moving beyond end 64 during a collision is the generally concave contour of upper wall 60. By giving upper wall 60 a concave contour, pathway follower 52 is not presented with any camming surface that might otherwise drive pathway follower 52 towards either ingress segment 46 or egress segment 50.

As the user continues to push on bin cover 16, pathway follower 52 will continue to move in a diagonally upward direction until, at position J, pathway follower 52 encounters upper wall 60. Upper wall 60 obstructs further movement of bin cover 16 and this obstruction is communicated back to the user via haptic feedback. In some embodiments, bumpers may be used elsewhere in the latch arraignment to inhibit further upward movement of pathway follower 52 instead of upper wall 60.

Once the user receives the haptic feedback indicating that bin cover 16 has reached the end of its travel, the user will release bin cover 16. When the user releases bin cover 16, hinge-engaging springs 30 will urge bin cover 16 towards the open position. Because there is no longer any engagement between pathway follower 52 and lower wall 62 of clearance segment 48, bin cover 16 is free to move towards the open position. As bin cover 16 moves towards the open position, pathway follower 52 moves along egress segment 50 through positions K and L, through gate 51, and will ultimately return to position A where it will be ready for the next close/open cycle to begin.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration in any way. Rather, the foregoing detailed description will provide those skilled in the art with a convenient road map for implementing the exemplary embodiment or exemplary embodiments. It should be understood that various changes can be made in the function and arrangement of elements without departing from the scope as set forth in the appended claims and the legal equivalents thereof.

1. A push-push latch arrangement comprising:
a component configured to move between a first position and a second position;
a latch component configured to engage the component, the latch component configured to move with respect to the component as the component moves between the first position and the second position;
a push-push pathway associated with one of the component and the latch component;
a pathway follower associated with another of the component and the latch component, the pathway follower engaged with the push-push pathway;
a first biasing component urging the pathway follower towards an egress segment of the push-push pathway; and
a damper engaged with the latch component and dampening movement of the latch component.

2. The push-push latch arrangement of claim 1, further comprising a second biasing component urging the component towards the first position.

3. The push-push latch arrangement of claim 2, wherein the second biasing component comprises a spring.

4. The push-push latch arrangement of claim 1, wherein an outer wall of a clearance segment of the push-push pathway has a concave curvature.

5. The push-push latch arrangement of claim 4, wherein the concave curvature extends along substantially an entire portion of the clearance segment.

6. The push-push latch arrangement of claim 1, wherein the component pivots between the first position and the second position.

7. The push-push latch arrangement of claim 1, wherein the pathway follower has a contour configured to engage a clearance segment of the push-push pathway.

8. The push-push latch arrangement of claim 1, wherein the first biasing component comprises a spring.

9. The push-push latch arrangement of claim 1, wherein the damper is configured to retard movement of the latch component such that the pathway follower requires a predetermined period of time to move from a clearance segment of the push-push pathway to the egress segment of the push-push pathway.

10. The push-push latch arrangement of claim 9, wherein the predetermined period of time comprises at least approximately five milliseconds.

11. The push-push latch arrangement of claim 1, wherein the damper comprises a viscous damper.

12. The push-push latch arrangement of claim 1, wherein the damper comprises a rotary damper.

13. The push-push latch arrangement of claim 1, wherein the component comprises a lid for a bin.

14. The push-push latch arrangement of claim 13, wherein the bin is integrated into a dashboard of a vehicle.
